(19) United States
(12) Patent Application Publication
(10) Pub. No.: US 2012/0157256 A1
(43) Pub. Date: Jun. 21, 2012

(54) BEARING OIL SUPPLY STRUCTURE FOR WIND TURBINE GENERATOR

(75) Inventors: Hiroaki TAKEUCHI, Tokyo (JP); Hideaki NISHIDA, Tokyo (JP); Yoshimi KAGIMOTO, Tokyo (JP); Akihiko MATSUI, Tokyo (JP); Noriyuki HAYASHI, Tokyo (JP); Yasuyoshi TOZAKI, Tokyo (JP)

(73) Assignee: MITSUBISHI HEAVY INDUSTRIES, LTD., Tokyo (JP)

(21) Appl. No.: 13/327,980

(22) Filed: Dec. 16, 2011

(30) Foreign Application Priority Data
Dec. 20, 2010 (JP) 2010-283420

(51) Int. Cl. F16H 57/04; F16H 1/28

(52) U.S. Cl. 475/159

(57) ABSTRACT

In a bearing oil supply structure for a wind turbine generator provided with a planetary-type planet gear box having a planet gear that rotates about a planet pin fixed to a carrier with a slide bearing interposed therebetween, lubrication of the slide bearing is achieved by supplying lubricant oil by using an oil bath in a lower rotation region and by supplying lubricant oil by injecting lubricant oil pressure-fed from a lubricant oil source through a nozzle in an upper rotation region.

### CROSS REFERENCE TO RELATED APPLICATIONS

This application claims benefit of Japanese Applications No. 2010-283420 filed in Japan on Dec. 20, 2010, the contents of which is hereby incorporated by its reference.

### BACKGROUND OF THE INVENTION

1. Field of the Invention

The present invention relates to a bearing oil supply structure for a wind turbine generator applied to a bearing part of a planet gear box mechanism that steps up rotation of a rotor head and transfers the stepped-up rotation to a generator, for example.

2. Description of Related Art

A wind turbine generator has a rotor head with blades that rotates under the force of wind hitting the blades, and a generator that is driven by the rotation of the rotor stepped up by a gear box to generate electric power.

An example of the gear box that steps up the rotation of the rotor head is a planetary-type planet gear box mechanism. The planetary-type planet gear box mechanism has a plurality of planet gears attached to a carrier that rotates integrally with an input shaft, and the planet gears revolves in engagement with a sun gear that rotates integrally with an output shaft and an internal gear fixed to a housing of the gear box. That is, the planetary-type planet gear box mechanism steps up the number of rotation of the carrier coupled to the input shaft (the numbers of revolutions of the planet gears) according to the gear ratio among the planet gears, the sun gear and the internal gear, and outputs the stepped up rotation from the output shaft coupled to the sun gear.

In the planetary-type planet gear box mechanism described above, each planet gear is rotatably supported on the carrier with a planet bearing interposed therebetween. The planet bearing is typically a roller bearing or a slide bearing. In the case where the slide bearing is used as the planet gear in such a planetary-type planet gear box mechanism, an oil supply channel is formed in the carrier to achieve lubrication in the upper rotation region where no oil bath can be used for lubrication.

Besides, a lubrication system for a planet gear train is described in Japanese Translation of PCT International Application, Publication No. Hei 9-507284, for example. According to this conventional technique, lubricant oil is supplied to a channel formed in a journal pin from the outer surface of the pin and then guided through the channel to the surroundings of the pin to achieve the outer surface of the pin and the bores of the planet gears.

The bearing oil supply structure that has slide bearings as the planet bearings of the planetary-type planet gear box mechanism and a carrier having an oil supply channel formed therein for lubrication, such as the conventional one described above, has a problem that it is a complicated structure with a large number of components and is expensive.

In view of such circumstances, it is desirable that a wind turbine generator that incorporates slide bearings as planet bearings of a planetary-type planet gear box mechanism has a bearing oil supply structure that can be reduced in number of components through simplification of the oil supply system and in cost through simplification of the assembly.

### BRIEF SUMMARY OF THE INVENTION

The present invention has been devised in view of the circumstances described above, and an object of the present invention is to provide a bearing oil supply structure for a wind turbine generator that can be reduced in number of components through simplification of the oil supply system thereof and in cost through simplification of the assembly thereof.

In order to attain the object described above, the present invention provides the following solutions.

A bearing oil supply structure according to a first aspect of the present invention is a bearing oil supply structure for a wind turbine generator comprising a planetary-type planet gear box having a planet gear that rotates about a planet pin fixed to a carrier with a slide bearing interposed therebetween, wherein lubrication of said slide bearing is achieved by supplying lubricant oil by using an oil bath in a lower rotation region and by supplying lubricant oil by injecting lubricant oil pressure-fed from a lubricant oil source through a nozzle in an upper rotation region.

With the bearing oil supply structure for a wind turbine generator according to the first aspect of the present invention, since lubrication of the slide bearing is achieved by supplying lubricant oil by using an oil bath in a lower rotation region and by supplying lubricant oil by injecting lubricant oil pressure-fed from a lubricant oil source through a nozzle in an upper rotation region, the lubricant oil can be reliably supplied to achieve lubrication of the slide bearing in the lower rotation region and the upper rotation region by a simple structure with a reduced number of components.

In the first aspect of the present invention, it is preferred that said planet pin has a main lubricant oil channel formed to extend in the axial direction form a lubricant oil inlet opening at one end and a radial lubricant oil channel formed to radially extend from the main lubricant oil channel to an outer pin surface, and the lubricant oil injected through said nozzle is supplied to a sliding part of said slide bearing through said lubricant oil inlet, said main lubricant oil channel and said radial lubricant oil channel. This allows the lubricant oil injected through the nozzle to be reliably supplied to the sliding surface of the slide bearing to achieve lubrication.

In this case, a lubricant oil receiving pan is preferably provided at said lubricant oil inlet for receiving the lubricant oil injected through said nozzle and guiding the lubricant oil into said main lubricant oil channel. This allows the lubricant oil injected through the nozzle to be efficiently guided to the lubricant oil inlet and more reliably supplied to the sliding surface of the slide bearing to achieve lubrication.

In the first aspect of the present invention, the lubricant oil injected through said nozzle may be directly supplied to said slide bearing. In this case also, the lubricant oil injected through the nozzle can be supplied to the sliding surface of the slide bearing to achieve lubrication.

A bearing oil supply structure according to a second aspect of the present invention is a bearing oil supply structure for a wind turbine generator comprising a planetary-type planet gear box having a planet gear that rotates about a planet pin fixed to a carrier with a slide bearing interposed therebetween, wherein lubrication of said slide bearing is achieved by supplying lubricant oil by using an oil bath in a lower rotation region and by supplying lubricant oil reserved during oil bathing in an upper rotation region.

With the bearing oil supply structure for a wind turbine generator according to the second aspect of the present invention, since lubrication of the slide bearing is achieved by supplying lubricant oil by using an oil bath in a lower rotation region and by supplying lubricant oil reserved during oil bathing in an upper rotation region, the lubricant oil can be reliably supplied to achieve lubrication of the slide bearing in the lower rotation region and the upper rotation region by a simple structure with a reduced number of components.

In the second aspect of the present invention, said planet pin can have a main lubricant oil channel formed to extend in the axial direction form a lubricant oil inlet opening at one end and a radial lubricant oil channel formed to radially extend from the main lubricant oil channel to an outer pin surface, and a lubricant oil receiving pan can be provided at said lubricant oil inlet, so that lubricant oil scooped and reserved in said lubricant oil receiving pan during said oil bathing can be supplied to a sliding part of said slide bearing through said lubricant oil inlet, said main lubricant oil channel and said radial lubricant oil channel. This allows the lubricant oil to be reliably reserved and supplied to the lower rotation region and the upper rotation region to achieve lubrication of the slide bearing by a simple structure with a reduced number of components.

In the second aspect of the present invention, a lubricant oil receiving pan can be provided in the vicinity of an end of said slide bearing, and the lubricant oil scooped and reserved in said lubricant oil receiving pan during said oil bathing can be directly supplied to said slide bearing. In this case, the reserved lubricant oil can be supplied to a sliding surface of the slide bearing to achieve lubrication.

In the second aspect of the present invention, it is preferred that an oil supply groove is formed in said planet pin by cutting a non-loaded surface thereof, a lubricant oil absorbing member is inserted into the oil supply groove, and lubricant oil absorbed and reserved in said lubricant oil absorbing member during said oil bathing is supplied to the sliding part of said slide bearing. In this case, the lubricant oil absorbed and reserved in the lubricant oil absorbing member can be supplied to the sliding surface of the slide bearing to achieve lubrication.

In this case, it is preferred that said lubricant oil absorbing member has an oil supply groove formed to extend in the axial direction of said planet pin, and the oil supply groove opens at one end and is closed at the other end. In this case, the lubricant oil can be introduced into and absorbed in the lubricant oil absorbing member in a shorter time.

A wind turbine generator according to a third aspect of the present invention comprises a bearing oil supply structure according to the first or second aspect of the present invention.

Since the wind turbine generator according to the third aspect of the present invention is provided with the bearing oil supply structure according to the first or second aspect of the present invention, the wind turbine generator is reliably and durable and is manufactured at low cost.

According to the present invention summarized above, even for a wind turbine generator provided with a planetary-type planet gear box having a planet gear that rotates about a planet pin fixed to a carrier with an inexpensive slide bearing interposed therebetween, there can be provided a bearing oil supply structure for the wind turbine generator that can be reduced in number of components through simplification of the oil supply system and in cost through simplification of the assembly. Therefore, the present invention has a remarkable advantage that the wind turbine generator provided with the planetary-type planet gear box can be improved in reliability and durability at low cost.

### BRIEF DESCRIPTION OF THE SEVERAL VIEWS OF THE DRAWINGS

FIG. 1 is a cross-sectional view showing a configuration of essential parts of a bearing oil supply structure for a wind turbine generator according to a first embodiment of the present invention;

FIG. 2 is a schematic diagram showing an example of a planetary-type planet gear box to which the bearing oil supply structure for the wind turbine generator according to the present invention is applied;

FIG. 3 is a schematic diagram showing a planetary-type planet gear box mechanism of the planetary-type planet gear box shown in FIG. 2 viewed from the axial direction thereof;

FIG. 4 is a side view of the wind turbine generator provided with a gear box to which a planet bearing structure according to the present invention is applied;

FIG. 5 is a schematic cross-sectional view showing a configuration of essential parts in a nacelle of the wind turbine generator shown in FIG. 4;

FIG. 6 is a cross-sectional view showing a configuration of essential parts of a bearing oil supply structure for a wind turbine generator according to a second embodiment of the present invention;

FIG. 7 is a cross-sectional view showing a configuration of essential parts of a bearing oil supply structure for a wind turbine generator according to a third embodiment of the present invention;

FIG. 8 is a front view of a first modification of a lubricant oil receiving pan shown in FIG. 7, viewed in the axial direction;

FIG. 9 is a front view of a second modification of the lubricant oil receiving pan shown in FIG. 7, viewed in the axial direction;

FIG. 10 are diagrams showing essential parts of a bearing oil supply structure for a wind turbine generator according to a fourth embodiment of the present invention, in which FIG. 10(a) is a front view of a planet pin viewed in the axial direction, and FIG. 10(b) is a cross-sectional view taken along the line A-A in FIG. 10(a); and

FIG. 11 are diagrams showing essential parts of a modification of the planet pin and lubricant oil absorbing members shown in FIG. 10, in which FIG. 11(a) is a front view of the planet pin and the lubricant oil absorbing members viewed in the axial direction, and FIG. 11(b) is a cross-sectional view taken along the line B-B in FIG. 11(a).

### DETAILED DESCRIPTION OF THE INVENTION

In the following, planet bearing structures of a wind turbine generator or the like according to embodiments of the present invention will be described with reference to the drawings.

### First Embodiment

A bearing oil supply structure for a wind turbine generator according to the present invention is suitable for a gear box having a planetary-type planet gear box mechanism of a wind turbine generator and in particular a gear box that has slide bearings as planet bearings.

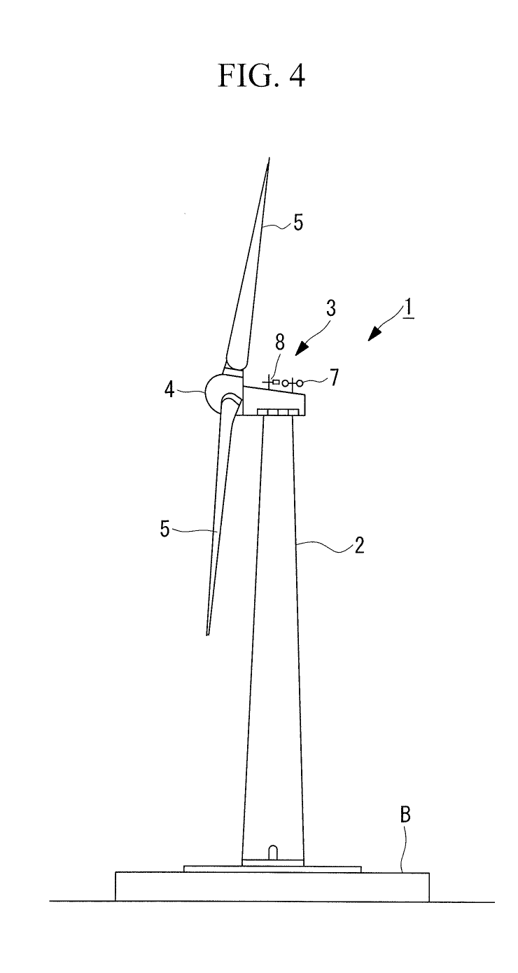

FIG. 4 shows a wind turbine generator 1 comprising a tower (referred to also as a pole) 2 standing on a base B, a nacelle 3 installed on the upper end of the tower 2, and a rotor head 4 provided on the front end of the nacelle 3 and supported so as to be rotatable about a substantially horizontal transverse axis of rotation.

The rotor head 4 is provided with a plurality of (three, for example) blades 5 radially arranged about the axis of rotation. The force of wind hitting the blades 5 in the direction of the axis of rotation of the rotor head 4 is converted into a mechanical power to make the rotor head 4 rotate about the axis of rotation.

The nacelle 3 is provided with an anemometer 7 for measuring the wind speed in the surroundings and an anemoscope 8 for measuring the wind direction at appropriate positions on the outer periphery thereof (on an upper part thereof, for example).

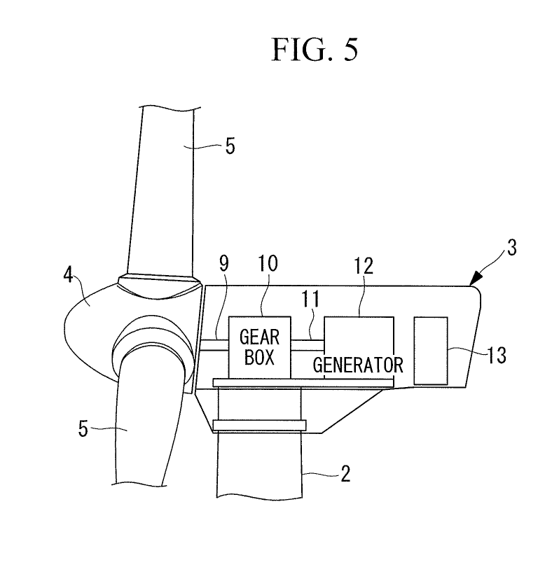

In the nacelle 3, as shown in FIG. 5, for example, a gear box 10 coupled to the rotor head 4 by a main shaft 9 and a generator 12 coupled to an output shaft 11 of the gear box 10 are provided. That is, the number of rotations is stepped up as the rotation of the rotor head 4 is transferred to the output shaft 11 of the gear box 10 to which the rotor head 4 is coupled by the main shaft 9. The generator 12 is driven at the number of rotations at the output side stepped up by the gear box 10 to generate electric power.

In the nacelle 3, there is further provided a wind turbine controller 13 for controlling various operations of the wind turbine generator 1.

The gear box 10 described above is typically formed by a combination of a plurality of stages of step-up mechanisms. The number of rotations of the main shaft 9 serving as the input shaft is stepped up to the final number of output rotations of the output shaft 11 through a plurality of step-up stages.

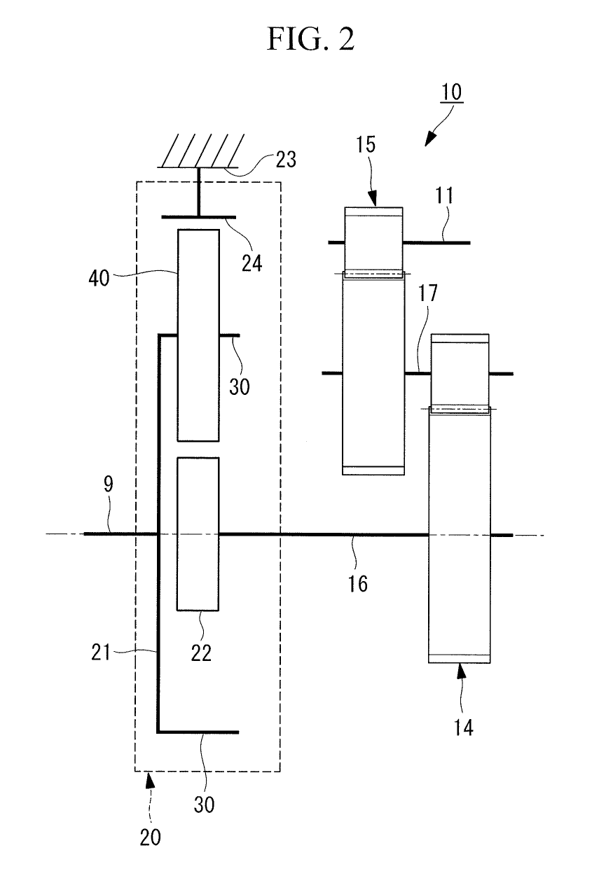

FIG. 2 is a schematic diagram showing an example of a gear box provided with the planetary-type planet gear box mechanism to which the bearing oil supply structure according to the present invention is applied, that is, a planetary-type planet gear box. In the drawing, the part enclosed by the dashed line is a low speed stage of the planetary-type planet gear box (referred to as a planetary-type gear box hereinafter) that performs a first-stage step-up. In this case, the number of rotations of the main shaft 9 is first stepped up by the planetary-type gear box 20 and then stepped up by a middle speed stage 14 and a high speed stage 15 to the number of output rotations of the output shaft 11. In the drawing, reference numeral 16 denotes a coupling shaft for transferring the output of the low speed stage of the planetary-type planet gear box to the middle speed stage 14, and reference numeral 17 denotes a coupling shaft for transferring the output of the middle speed stage 14 to the high speed stage 15.

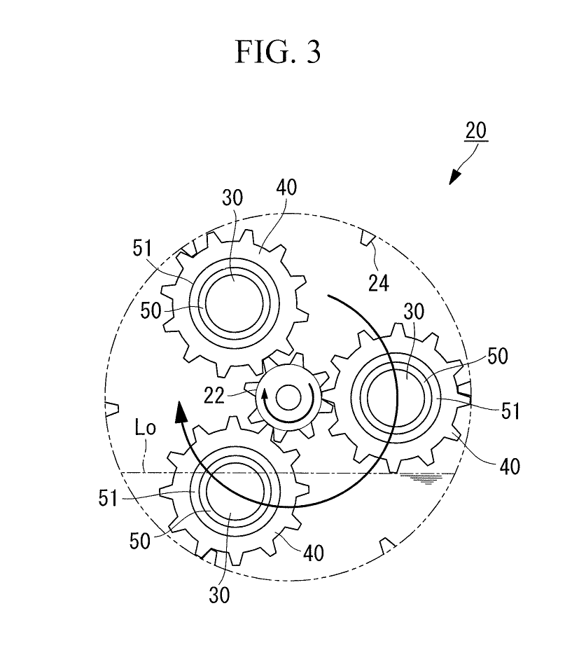

FIG. 3 is a schematic diagram showing a planetary-type planet gear box mechanism of the planetary-type gear box 20 that performs the first-stage step-up of the gear box 10, viewed from the axial direction, as an example of the planet gear device to which the bearing oil supply structure according to the present invention is applied.

In the case where the planetary-type gear box 20 is used as the gear box of the wind turbine generator 1, a carrier 21 of the planetary-type gear box 20 is coupled to the main shaft 9 and rotates with the main shaft 9. In the shown example, three planet pins 30 are fixed to the carrier 21, and a planet gear 40 is rotatably attached to each planet pin 30 with a slide bearing 50 and a bearing back metal 51 of the slide bearing 50 interposed therebetween.

In the planetary-type gear box 20, the three planet gears 40 are attached to the carrier 21 that rotates integrally with the main shaft 9 serving as the input shaft, and the planet gears 40 revolve in engagement with a sun gear 22 that rotates integrally with the coupling shaft (output shaft) 16 and an internal gear 24 fixed to a housing 23. That is, the planetary-type gear box 20 is a device that steps up the number of rotations of the carrier 21 coupled to the main shaft (input shaft) 9 (or the numbers of revolutions of the planet gears) according to the gear ratio among the planet gears 40, the sun gear 22 and the internal gear 24, and the stepped up number of revolutions is output to the two-stage step-up mechanism comprising the middle speed stage 14 and the high speed stage 15 through the coupling shaft 16 coupled to the sun gear 22.

The housing 23 in which the carrier 21 and the planet gears 40 revolve is filled with lubricant oil up to the level of an oil bath surface (lubricant oil surface) Lo shown in FIG. 3, for example. The level of the oil bath surface Lo is preferably high enough for at least an axial bore inner surface 40a of each revolving planet gear 40 to be immersed in the lubricant oil.

As described above, in the gear box 10 of the wind turbine generator 1, the slide bearing 50 mounted on the axial bore inner surface 40a of the planet gear 40 rotates with the planet gear 40 about the planet pin 30 fixed to the carrier 21.

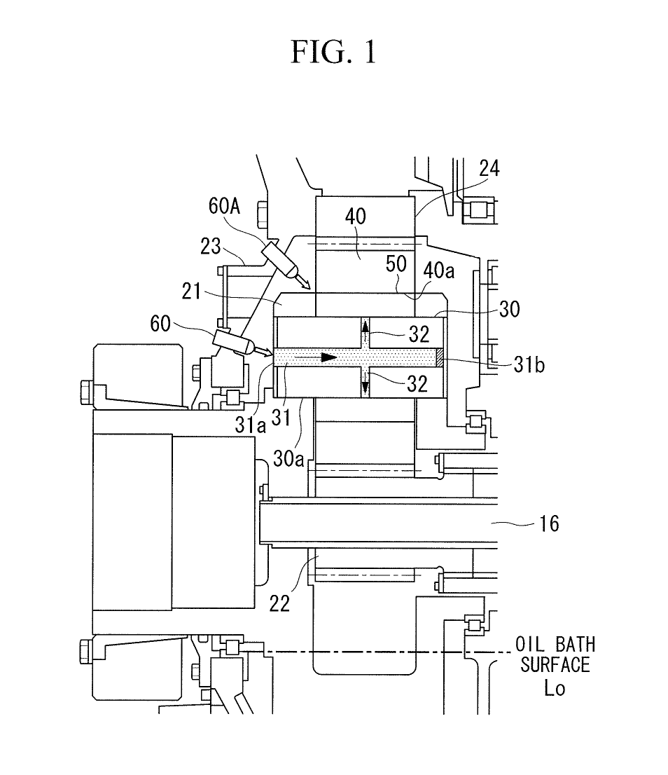

The bearing oil supply structure according to this embodiment shown in FIG. 1 is applied to the planetary-type planet gear box in which the planet gears 40 rotates about the planet pins 30 fixed to the carrier 21 through the action of the slide bearings 50. Lubrication of the slide bearings 50 is achieved by supplying lubricant oil by using an oil bath in a lower rotation region and by supplying lubricant oil by injecting lubricant oil pressure-fed from a lubricant oil source through a nozzle 60 in an upper rotation region.

In the lower rotation region, oil supply is achieved by the planet pins 30, the planet gears 40 and the slide bearings 50 revolving with the main shaft 9 and the carrier 21 passing through the lubricant oil in the housing 23. That is, the planet pins 30, the planet gears 40 and the slide bearings 50 are immersed in the lubricant oil when they go below the oil bath surface Lo during revolution, and in this oil-immersed state, the sliding surface or the like of the slide bearing 50 is supplied with the lubricant oil.

In the upper rotation region, oil supply is achieved by injecting lubricant oil pressure-fed from a lubricant oil source (not shown, a lubricant oil pump provided on the nacelle 3, for example) through the nozzle 60 fixed to the housing 23. In this case, one or more nozzles 60 are provided in the rotational direction (circumferential direction) so that the lubricant oil can be injected at appropriate times to the planet pins 30, the planet gears 40 and the slide bearings 50 revolving in the space above the oil bath surface Lo in the housing 23.

The planet pin 30 has a main lubricant oil channel 31 extending in the axial direction from a lubricant oil inlet 31a that opens at one end thereof and one or more radial lubricant oil channels 32 extending radially from the main lubricant oil channel 31 to an outer pin surface 30a. The main lubricant oil channel 31 shown is formed on the central axis of the planet pin 30, the lubricant oil inlet 31a of the main lubricant oil channel 31 opens in the end closer to the carrier 21, and an outlet opening of the main lubricant oil channel 31 formed in the end closer to the middle speed stage 14 is closed by a blocking member 31b.

The lubricant oil is injected through the nozzle 60 described above to the lubricant oil inlet 31a of the main lubricant oil channel 31 of the planet pin 30 with these lubricant oil channels. Although the lubricant oil can be constantly injected through the nozzle 60, the lubricant oil is preferably intermittently injected in synchronization with passage of the target lubricant oil inlet 31a.

The lubricant oil injected through the nozzle 60 enters the inside of the main lubricant oil channel 31 through the lubricant oil inlet 31a and flows toward the outlet opening closed by the blocking member 31b under the pressure of the injection. Then, the lubricant oil is supplied to the sliding part of the slide bearing 50 in contact with the outer pin surface 30a through the radial lubricant oil channel 32 branched midway from the main lubricant oil channel 31. That is, in the upper rotation region that includes no oil bath like the lower rotation region, lubrication is achieved by forced oil supply, which involves injecting the lubricant oil to the lubricant oil inlet 31a through the nozzle 60 to supply the lubricant oil to between the outer pin surface 30a and the inner surface of the slide bearing 50 through the radial lubricant oil channel 32.

As described above, lubrication of the slide bearings 50 is achieved by supplying the lubricant oil by using the oil bath in the lower rotation region and by supplying the lubricant oil by injecting the lubricant oil pressure-fed from the lubricant oil source through the nozzle 60 in the upper rotation region. As a result, even in the upper rotation region where no oil bath can be used for lubrication, lubrication can be reliably achieved by supplying the lubricant oil to the sliding surfaces of the slide bearings 50 by injecting the lubricant oil through the nozzle 60. Therefore, when the planet gears 40 revolve in engagement with the internal gear 24 in the housing 23, lubrication between the planet pins 30 and the slide bearings 50 is achieved with reliability. Since lubrication of the slide bearings 50 is achieved with reliability by a simple structure with a reduced number of components both in the lower rotation region and the upper rotation region, high reliability and high durability can be achieved.

In the embodiment described above, the lubricant oil is injected to the lubricant oil inlet 31a through the nozzle 60. However, as with a nozzle 60A shown in FIG. 1, for example, the lubricant oil may be injected to the slide bearing 50. If such a nozzle 60A is used, lubrication is achieved by directly supplying oil to the sliding surface of the slide bearing 50.

Although the nozzle 60A can be used by itself, the nozzle 60A may be used in combination with the nozzle 60 according to the embodiment described above.

### Second Embodiment

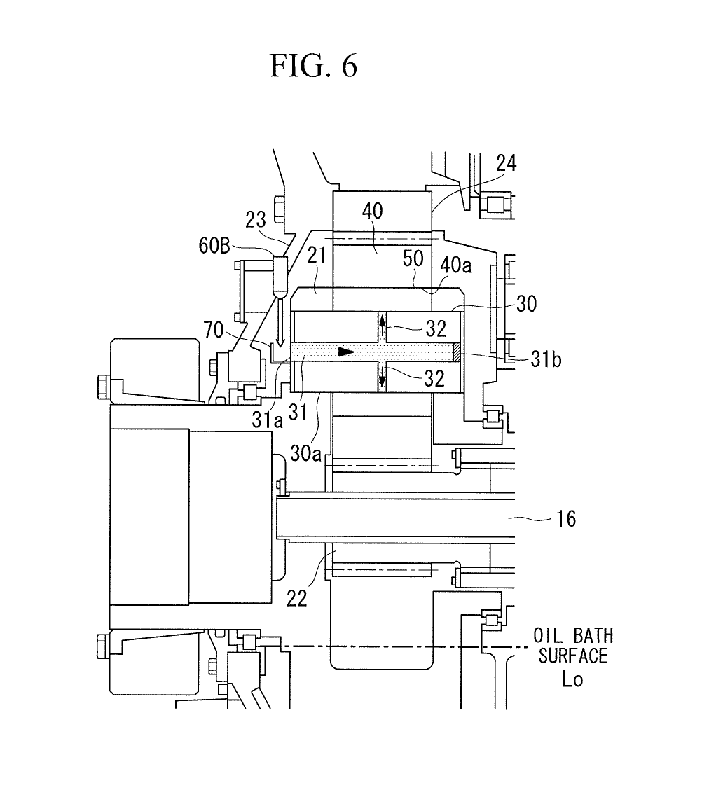

Next, a wind turbine generator according to a second embodiment of the present invention will be described with reference to FIG. 6. The same components as those in the embodiment described above are denoted by the same reference numerals, and detailed descriptions thereof will be omitted.

According to this embodiment, as shown in FIG. 6, for example, a lubricant oil receiving pan 70 is provided at the lubricant oil inlet 31a for receiving the lubricant oil injected through a nozzle 60B and guiding the lubricant oil into the main lubricant oil channel 31. The lubricant oil receiving pan 70 has the shape of a gutter formed by bending a plate into a substantially L-shaped cross section, for example, so that the lubricant oil receiving pan 70 accumulates the lubricant oil injected downward through the nozzle 60B with reliability and guides the lubricant oil into the main lubricant oil channel 31. Viewed from the axial direction of coupling to the main shaft 9, the lubricant oil receiving pan 70 can be V-shaped, arc-shaped or otherwise shaped to be bent toward the lubricant oil inlet 31a, for example, in order that the accumulated lubricant oil can be guided to the sliding surface with reliability.

With such a configuration, the lubricant oil injected through the nozzle 60B can be efficiently and reliably guided into the lubricant oil inlet 31a and reliably supplied to the sliding surface of the slide bearing 50 to achieve lubrication.

Although the nozzle 60B shown in the drawing is installed so as to inject the lubricant oil substantially vertically, the direction of the nozzle 60B is not particularly limited as far as the lubricant oil receiving pan 70 can reliably accumulate the lubricant oil, and the nozzle 60B may be installed so as to inject the lubricant oil toward the lubricant oil inlet 31a, as with the nozzle 60 shown in FIG. 1, for example.

In addition, the shape of the lubricant oil receiving pan 70 provided in this embodiment is not limited to the substantially L-shaped cross section described above, and the lubricant oil receiving pan 70 may have the shape of a gutter having an arc-shaped cross section according to a modification.

### Third Embodiment

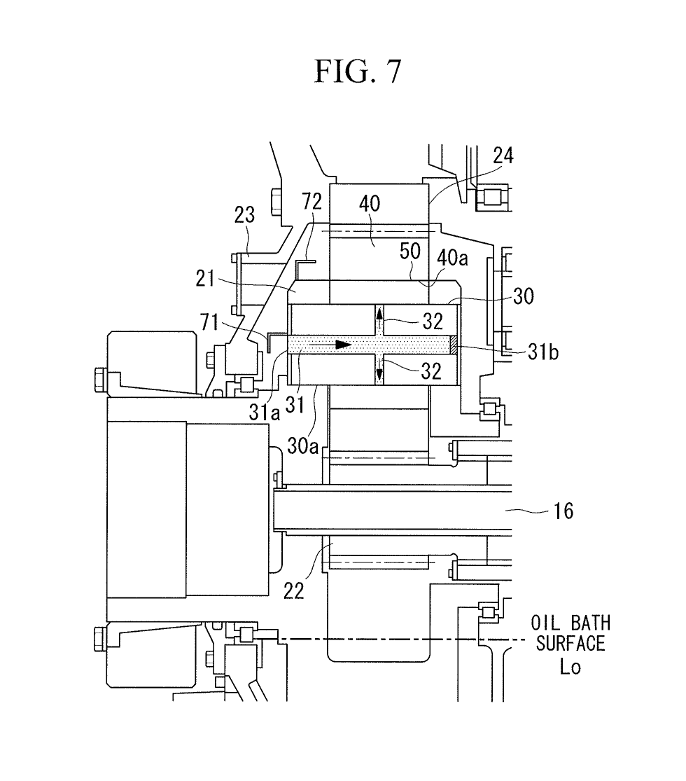

Next, a wind turbine generator according to a third embodiment of the present invention will be described with reference to FIGS. 7 to 9. The same components as those in the embodiments described above are denoted by the same reference numerals, and detailed descriptions thereof will be omitted.

According to this embodiment, lubrication of the slide bearings is achieved by supplying lubricant oil by using an oil bath in the lower rotation region and by supplying lubricant oil reserved during oil bathing in the upper rotation region. That is, in this embodiment, the forced lubrication by injecting the lubricant oil through the nozzle 60 described above is not performed.

More specifically, according to the embodiment shown in FIG. 7, the same main lubricant oil channel 31 and radial lubricant oil channel 32 as those in the embodiment described above are formed in the planet pin 30. At the lubricant oil inlet 31a, a lubricant oil receiving pan 71 having a substantially L-shaped cross section is provided in an inverted orientation compared with the lubricant oil receiving pan 70 described above. The lubricant oil receiving pan 71 is intended to scoop the lubricant oil during oil bathing and therefore is open upward when immersed in the lubricant oil.

The lubricant oil receiving pan 71 serves as a dipper to scoop and reserve the lubricant oil during oil bathing, and the lubricant oil scooped by and reserved in the lubricant oil receiving pan 71 flows into the main lubricant oil channel 31 through the lubricant oil inlet 31a and then is supplied to the sliding surface of the slide bearing 32 through the radial lubricant oil channel 32. That is, the lubricant oil receiving pan 71 in this embodiment is open upward during oil bathing to scoop the lubricant oil and reserve the lubricant oil to be supplied to the upper rotation region.

With such a bearing oil supply structure, the lubricant oil is supplied to the sliding parts of the slide bearings 50 through the lubricant oil inlet 31a, the main lubricant oil channel 31 and the radial lubricant oil channel 32, and no actuator such as a pump is needed. Therefore, the lubricant oil can be reliably reserved by a simple structure with a reduced number of components and can be reliably supplied both to the lower rotation region and the upper rotation region to achieve lubrication of the slide bearings 50.

The lubricant oil receiving pan 71 in this embodiment can also be replaced with a lubricant oil receiving pan 72 attached to the carrier 21 at a position close to one end of the slide bearing 50. The lubricant oil receiving pan 72 is intended to supply the lubricant oil scooped and reserved during oil bathing directly to the slide bearing as with the nozzle 60A described above. With such a configuration, the lubricant oil can also be reliably reserved by a simple structure with a reduced number of components, and the reserved lubricant oil can be supplied to the sliding surface of the slide bearing 50 in the upper rotation region to achieve lubrication.

The lubricant oil receiving pan 72 can also be used in combination with the lubricant oil receiving pan 71 described above.

Viewed from the axial direction of coupling to the main shaft 9 (that is, in front view), the lubricant oil receiving pans 71 and 72 in this embodiment can be V-shaped, arc-shaped or otherwise shaped to be bent toward the lubricant oil inlet 31a, for example, in order that the reserved lubricant oil can be guided to the sliding surface with reliability.

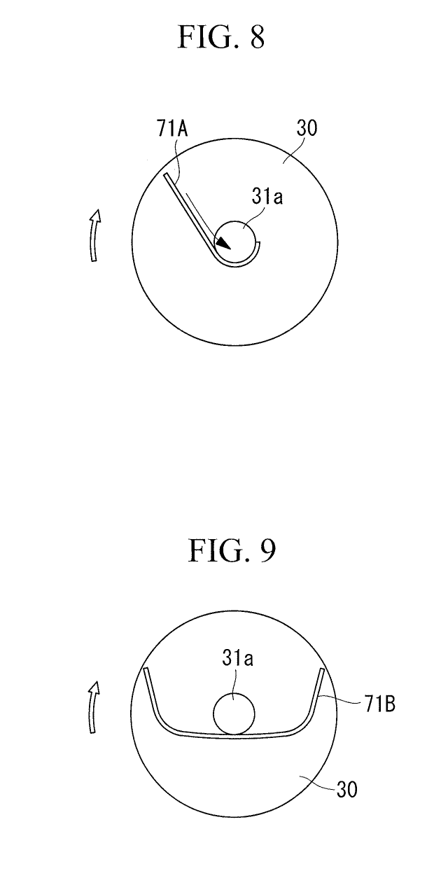

Alternatively, the lubricant oil receiving pans 71 and 72 described above may have the shapes shown in FIGS. 8 and 9, for example. A lubricant oil receiving pan 71A according to a first modification shown in FIG. 8 is substantially inverted-J shaped. When the planet pin 30 moving in the clockwise direction shown by the hollow arrow in the drawing leaves the oil bath, the lubricant oil reserved in the lubricant oil receiving pan 71A is guided along the inclined surface to the lubricant oil inlet 31a.

A lubricant oil receiving pan 71B according to a second modification shown in FIG. 9 is substantially U-shaped. When the planet pin 30 moving in the clockwise direction shown by the hollow arrow in the drawing leaves the oil bath, the lubricant oil reserved in the lubricant oil receiving pan 71B is guided to the lubricant oil inlet 31a. In this case, since the lubricant oil receiving pan 71B is substantially U-shaped or has a bowl-like shape, a sufficient amount of lubricant oil can be easily reserved.

These lubricant oil receiving pans 71A and 71B according to the modifications allow the lubricant to be reliably reserved by a simple structure with a reduced number of components and reliably supplied to the lower rotation region and the upper rotation region to achieve lubrication of the slide bearings 50, as with the lubricant oil receiving pan 71 described above.

### Fourth Embodiment

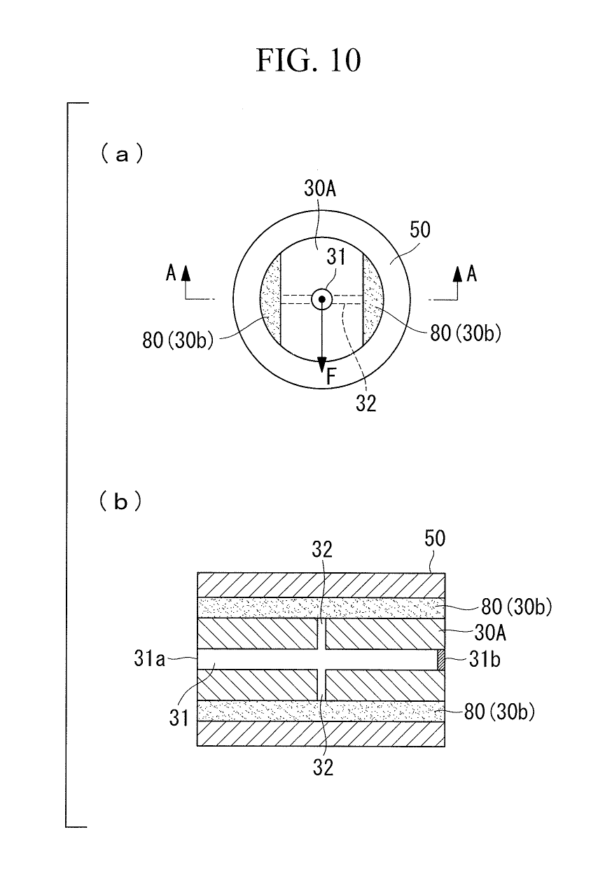

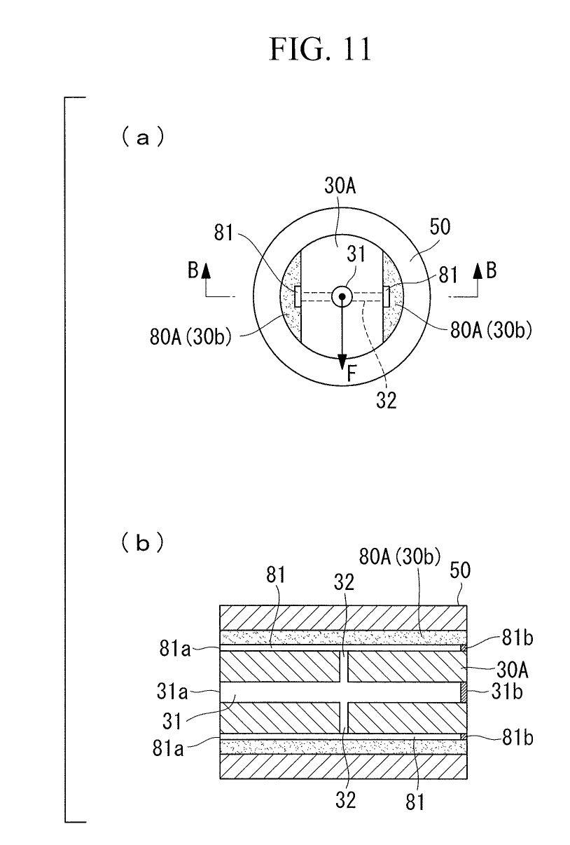

Finally, a wind turbine generator according to a fourth embodiment of the present invention will be described with reference to FIGS. 10 and 11. The same components as those in the embodiments described above are denoted by the same reference numerals, and detailed descriptions thereof will be omitted.

According to this embodiment, a planet pin 30A has oil supply grooves 30b formed by cutting non-loaded surfaces thereof, and lubricant oil absorbing members 80 are inserted in the oil supply grooves 30b. The planet pin 30A is loaded only in the vertical direction as shown by the arrow F in FIG. 10(a), and the opposite side surfaces of the planet pin 30A are non-loaded surfaces. Thus, as shown in the drawing, the non-loaded, opposite side parts of the planet pin 30A having a circular cross section are removed to form spaces between the planet pin 30A and the inner surface of the slide bearing 50, which serve as the oil supply grooves 30b.

The lubricant oil absorbing members 80 made of sponge or the like inserted in the oil supply grooves 30b described above absorbs and retains the lubricant oil during oil bathing and discharges the lubricant oil to achieve lubrication of the sliding part of the slide bearing 50 in the upper rotation region where no oil bathing occurs. In this way, a sufficient amount of lubricant oil absorbed and retained in the lubricant oil absorbing member 80 can be supplied to the sliding surface of the slide bearing 50 to reliably achieve lubrication.

According to a modification, as an alternative to the lubricant oil absorbing members 80 described above, lubricant oil absorbing members 80A having an oil supply groove 81 extending in the axial direction of the planet pin 30A can be inserted into the oil supply grooves 30b, as shown in FIG. 11, for example. The oil supply groove 81 is open at one end to form an inlet opening 81a that facilitates introduction of the lubricant oil during oil bathing and is closed by a blocking member 81b at the other end.

The lubricant oil absorbing member 80A having the oil supply groove 81 can introduce and absorb the lubricant oil into the lubricant oil absorbing member 80A in a shorter time and therefore can more easily reserve a sufficient amount of lubricant oil during oil bathing.

In the embodiment and the modification described above, the planet pin 30A has the main lubricant oil channel 31 and the radial lubricant oil channel 32 formed therein. However, with the configuration using the lubricant oil absorbing members 80 or 80A, the main lubricant oil channel 31 and the radial lubricant oil channel 32 can be omitted, and the lubricant oil can be directly supplied from the lubricant oil absorbing members 80 or 80A to the slide bearing 50.

According to the embodiments of the present invention described above, as to the bearing oil supply structure provided with the planetary-type planet gear box in which the planet gear 40 rotates about the planet pin 30 or 30A fixed to the carrier 21 with the inexpensive slide bearing 50 interposed therebetween, the number of components can be reduced through simplification of the oil supply system and the cost can be reduced through simplification of the assembly. Therefore, the wind turbine generator 1 provided with the planetary-type planet gear box can be manufactured at low cost and improved in reliability and durability.

Note that the present invention is not limited to the embodiments described above and can be modified as required without departing form the spirit of the present invention.

What is claimed is:

1. A bearing oil supply structure for a wind turbine generator comprising a planetary-type planet gear box having a planet gear that rotates about a planet pin fixed to a carrier with a slide bearing interposed therebetween,
wherein lubrication of said slide bearing is achieved by supplying lubricant oil by using an oil bath in a lower rotation region and by supplying lubricant oil by injecting lubricant oil pressure-fed from a lubricant oil source through a nozzle in an upper rotation region.

2. The bearing oil supply structure for a wind turbine generator according to claim 1, wherein said planet pin has a main lubricant oil channel formed to extend in the axial direction form a lubricant oil inlet opening at one end and a radial lubricant oil channel formed to radially extend from the main lubricant oil channel to an outer pin surface, and
the lubricant oil injected through said nozzle is supplied to a sliding part of said slide bearing through said lubricant oil inlet, said main lubricant oil channel and said radial lubricant oil channel.

3. The bearing oil supply structure for a wind turbine generator according to claim 1, wherein the lubricant oil injected through said nozzle is directly supplied to said slide bearing.

4. The bearing oil supply structure for a wind turbine generator according to claim 2, wherein the lubricant oil injected through said nozzle is directly supplied to said slide bearing.

5. The bearing oil supply structure for a wind turbine generator according to claim 2, wherein a lubricant oil receiving pan is provided at said lubricant oil inlet for receiving the lubricant oil injected through said nozzle and guiding the lubricant oil into said main lubricant oil channel.

6. A bearing oil supply structure for a wind turbine generator comprising a planetary-type planet gear box having a planet gear that rotates about a planet pin fixed to a carrier with a slide bearing interposed therebetween,
wherein lubrication of said slide bearing is achieved by supplying lubricant oil by using an oil bath in a lower rotation region and by supplying lubricant oil reserved during oil bathing in an upper rotation region.

7. The bearing oil supply structure for a wind turbine generator according to claim 6, wherein said planet pin has a main lubricant oil channel formed to extend in the axial direction form a lubricant oil inlet opening at one end and a radial lubricant oil channel formed to radially extend from the main lubricant oil channel to an outer pin surface, and
a lubricant oil receiving pan is provided at said lubricant oil inlet, so that lubricant oil scooped and reserved in said lubricant oil receiving pan during said oil bathing is supplied to a sliding part of said slide bearing through said lubricant oil inlet, said main lubricant oil channel and said radial lubricant oil channel.

8. The bearing oil supply structure for a wind turbine generator according to claim 6, wherein a lubricant oil receiving pan is provided in the vicinity of an end of said slide bearing, and the lubricant oil scooped and reserved in said lubricant oil receiving pan during said oil bathing is directly supplied to said slide bearing.

9. The bearing oil supply structure for a wind turbine generator according to claim 7, wherein a lubricant oil receiving pan is provided in the vicinity of an end of said slide bearing, and the lubricant oil scooped and reserved in said lubricant oil receiving pan during said oil bathing is directly supplied to said slide bearing.

10. The bearing oil supply structure for a wind turbine generator according to claim 6, wherein an oil supply groove is formed in said planet pin by cutting a non-loaded surface thereof, a lubricant oil absorbing member is inserted into the oil supply groove, and lubricant oil absorbed and reserved in said lubricant oil absorbing member during said oil bathing is supplied to a sliding part of said slide bearing.

11. The bearing oil supply structure for a wind turbine generator according to claim 10, wherein said lubricant oil absorbing member has an oil supply groove formed to extend in the axial direction of said planet pin, and the oil supply groove opens at one end and is closed at the other end.

12. A wind turbine generator comprising a bearing oil supply structure according to claim 1.
